(19) United States
(12) Patent Application Publication
(10) Pub. No.: US 2026/0200551 A1
(43) Pub. Date: Jul. 16, 2026

(54) AIR LAYER DRAG REDUCTION NOZZLE PLATE AND FLAP

(71) Applicant: Airglide AI, Inc., FORT LAUDERDALE, FL (US)

(72) Inventors: Richard Poe, Fort Lauderdale, FL (US); David Bell, Fort Lauderdale, FL (US); Danilo Contreras, Davie, FL (US); Alexander Taber, Deerfield Beach, FL (US); Jamie Broyles, Meeker, OK (US); Eric Capron, Prague, OK (US); Nicholas Spatola, Fort Lauderdale, FL (US)

(73) Assignee: Airglide AI, Inc., FORT LAUDERDALE, FL (US)

(21) Appl. No.: 19/564,075

(22) Filed: Mar. 11, 2026

Related U.S. Application Data
(63) Continuation-in-part of application No. 19/075,734, filed on Mar. 10, 2025.
(63) Continuation-in-part of application No. 18/948,969, filed on Nov. 15, 2024, now Pat. No. 12,630,261.
Application No. 18/948,969 is a continuation-in-part of application No. 18/219,375, filed on Jul. 7, 2023, now Pat. No. 12,263,914.
Application No. 18/219,375 is a continuation-in-part of application No. 18/119,324, filed on Mar. 9, 2023, now Pat. No. 12,097,932.
(60) Provisional application No. 63/427,144, filed on Nov. 22, 2022.
(60) Provisional application No. 63/439,306, filed on Jan. 17, 2023.
(60) Provisional application No. 63/454,549, filed on Mar. 24, 2023.
(60) Provisional application No. 63/599,360, filed on Nov. 15, 2023.
(60) Provisional application No. 63/563,086, filed on Mar. 8, 2024.
(60) Provisional application No. 63/563,250, filed on Mar. 8, 2024.
(60) Provisional application No. 63/770,321, filed on Mar. 11, 2025.
(60) Provisional application No. 63/789,183, filed on Apr. 15, 2025.
(60) Provisional application No. 63/952,245, filed on Dec. 31, 2025.

(51) Int. Cl. B63B 1/38; B63B 13/00

(52) U.S. Cl. CPC B63B 1/38; B63B 2001/387; B63B 2013/005

(57) ABSTRACT

An air layer drag reduction nozzle assembly and retrofit insert for marine vessels is disclosed. The disclosure provides an open cavity and a longitudinal engagement area. A fitting frame is removably affixed to the engagement area and defines an opening that receives a nozzle flap. The flap is hingedly coupled to the fitting frame along a lateral axis extending between port and starboard sides, allowing rotation between closed and open positions. In the closed position, the flap reduces hydrodynamic drag when an air lubrication system is inactive. In the open position, the flap guides gaseous flow from a gas flow inlet toward a direction substantially parallel to the hull. The fitting frame is configured for retrofit installation within an existing sea chest cavity such that an outer surface forms a substantially flush transition with the exterior hull surface. Methods for retrofitting marine vessels are also disclosed.

### CROSS-REFERENCE TO RELATED APPLICATIONS

This application is a continuation-in-part of co-pending U.S. patent application Ser. No. 19/075,734, entitled “An Aerodynamically Enhanced Air Lubrication Nozzle And Flap,” filed Mar. 10, 2025, and is also a continuation-in-part of co-pending U.S. patent application Ser. No. 18/948,969, entitled “System And Method For Enhanced Marine Vessel Efficiency Using Integrated Hull Optimizations,” filed Nov. 15, 2024.

U.S. patent application Ser. No. 19/075,734 is a continuation-in-part of U.S. patent application Ser. No. 18/948,969, entitled “System and Method for Enhanced Marine Vessel Efficiency Using Integrated Hull Optimizations,” filed Nov. 15, 2024, and also claims priority as a continuation-in-part of U.S. patent application Ser. No. 18/219,375, entitled “A System and Method for Delivering Air to A Submerged Ship Surface,” filed Jul. 7, 2023.

U.S. patent application Ser. No. 18/948,969 is a continuation-in-part of U.S. patent application Ser. No. 18/219,375, which itself is a continuation-in-part of U.S. patent application Ser. No. 18/119,324, entitled “A System and Method for Reducing Drag On Hulls of Marine Crafts Thereby Increasing Fluid Dynamic Efficiencies,” filed Mar. 9, 2023, now U.S. Pat. No. 12,097,932.

U.S. patent application Ser. No. 18/119,324 claims the benefit of priority pursuant to 35 U.S.C. § 119(e) to U.S. Provisional Patent Application Ser. No. 63/439,306, filed Jan. 17, 2023, and U.S. Provisional Patent Application Ser. No. 63/427,144, filed Nov. 22, 2022.

U.S. patent application Ser. No. 18/219,375 also claims priority pursuant to 35 U.S.C. § 119(e) to U.S. Provisional Patent Application Ser. No. 63/454,549, entitled “A System and Method for Delivering Air to A Submerged Ship Surface,” filed Mar. 24, 2023, and U.S. Provisional Patent Application Ser. No. 63/599,360, entitled “A Drag-Reducing Bow Thruster Cover for Maritime Vessels,” filed Nov. 15, 2023.

U.S. patent application Ser. No. 19/075,734 further claims priority pursuant to 35 U.S.C. § 119(e) to U.S. Provisional Patent Application Ser. No. 63/563,086, entitled “An Aerodynamically Enhanced Air Lubrication Nozzle and Flap System For V-Shaped Hull Surfaces,” filed Mar. 8, 2024, and U.S. Provisional Patent Application Ser. No. 63/563,250, entitled “Air Lubrication Nozzle With Enhanced Bi-Foil Flap System,” filed Mar. 8, 2024.

This application further claims the benefit of priority pursuant to 35 U.S.C. § 119(e) to U.S. Provisional Patent Application Ser. No. 63/770,321, entitled “Air Lubrication Nozzle Retrofit Plate And Flap,” filed Mar. 11, 2025; U.S. Provisional Patent Application Ser. No. 63/789,183, entitled “Flow Enhancing Sea Chest,” filed Apr. 15, 2025; and U.S. Provisional Patent Application Ser. No. 63/952,245, entitled “Air Lubrication Nozzle Assembly With Fixed-Angle Flap For Directed Air Flow,” filed Dec. 31, 2025.

All of the above applications are hereby incorporated by reference in their entireties for all purposes, and for their teachings therein.

### FIELD OF THE INVENTION

The present invention relates to air lubrication systems and methods for energy efficient upgrades to a marine vessel's hull, including for retrofit and new build applications.

### BACKGROUND

Air lubrication systems (ALS) have been developed to reduce the hydrodynamic resistance of vessels by introducing a layer of air between the ship's hull and the surrounding water. This technology aims to decrease fuel consumption and emissions by reducing drag forces acting on the hull. Various air lubrication methods have been introduced over the years, including solutions from companies such as Silverstream, Foreship, and Alfa Laval. These systems typically involve injecting compressed air through a network of outlets positioned along the ship's hull. The air forms a thin, lubricating cloud, allowing the vessel to glide more efficiently through the water. However, despite the theoretical advantages of ALS, practical implementation has revealed several limitations that hinder their long-term effectiveness and widespread adoption.

Many currently deployed ALS technologies operate by injecting compressed air through distributed outlets at the hull, producing large quantities of small bubbles that are entrained in the boundary layer flow. The generation of these bubbles is commonly associated with turbulent shear and vortex interactions within the boundary layer, often described in relation to Kelvin-Helmholtz type instabilities that promote breakup of the injected air stream into microbubbles. While this approach can introduce localized regions of reduced density near the hull, the resulting two-phase mixture does not form a continuous air layer. Instead, the dispersed microbubble field frequently increases turbulence intensity and can introduce additional viscous and mixing losses within the boundary layer. As a result, the drag reduction benefits are often inconsistent and may be partially offset by the hydrodynamic penalties associated with maintaining a turbulent bubble suspension.

One of the primary issues with existing ALS is the generation of additional drag when the system is not actively in use. Many air lubrication designs rely on open cavities or protruding structures that remain exposed even when air is not being injected. These elements create resistance, counteracting the efficiency gains the system aims to achieve. Furthermore, traditional ALS designs often lack adaptability to real-world maritime conditions. In rough seas or unpredictable weather, operators frequently disable the system to prevent instability or excessive air loss. When this occurs, the non-retractable components of the system contribute to increased drag, negating the benefits of air lubrication and leading to higher fuel consumption.

Another limitation of existing systems is their simplistic on-off operation, which does not account for varying environmental conditions or ship speeds. The inability to dynamically regulate airflow or mitigate the negative effects of an inactive system further reduces operational efficiency. In some cases, vessels equipped with ALS have reported marginal or even negative fuel savings due to the drag effects imposed by non-functional system components. Additionally, retrofitting ALS onto existing ships presents logistical challenges, as the hull must be modified to accommodate the necessary air injection mechanisms. These challenges, combined with inconsistent performance, have led to skepticism regarding the long-term viability of air lubrication as a fuel-saving measure.

Air layer drag reduction (ALDR) systems represent a more advanced approach in which a substantially continuous air film or plastron is maintained beneath portions of the vessel hull. When properly established, this thin air layer separates the hull surface from direct contact with water, dramatically reducing skin-friction drag relative to bubble-based ALS methods. However, maintaining such a continuous air layer requires careful control of the water-air interface so that water does not collapse the air film. In practice, this requires that the local water flow be displaced slightly below the hull surface so that injected air can spread laterally and remain attached along the hull.

Some existing ALDR approaches attempt to maintain this interface by incorporating recessed cavities or steps within the hull that trap air beneath the vessel. Although such cavities can help sustain the air layer during operation, they introduce several disadvantages. Permanent recesses in the hull can generate additional hydrodynamic resistance when the system is inactive and may also produce undesirable flow disturbances, including localized cavitation and vortex formation at cavity edges. These effects reduce overall efficiency and limit the practicality of cavity-based solutions, particularly for vessels seeking retrofit options.

The present invention expands on our previous patent U.S. Pat. No. 12,263,914, and application U.S. Ser. No.: Ser. No. 19/075,734, which address these inefficiencies by introducing a flush-close flap system that eliminates drag when the ALDR is inactive. Unlike conventional modifications, which typically requires sealing off or removing the sea chests, the proposed system incorporates a retrofit mechanism that allows for the integration of a streamlined, closable flap. This design ensures that when air is turned off, the flap seamlessly seals the opening, thereby restoring the hull's original hydrodynamic efficiency. This solution provides an immediate performance enhancement to ships already equipped with ALS, offering a practical and cost-effective retrofit alternative.

Thus, there is a pressing need for a system that not only enhances the effectiveness of air lubrication when in operation but also eliminates drag when the system is deactivated. The present invention directly addresses these concerns by offering a retrofit solution that seamlessly integrates with existing ship infrastructure. By doing so, it allows vessels to maximize fuel savings while mitigating the drawbacks of current ALS implementations. This innovation represents a significant step forward in maritime efficiency, providing ship operators with a reliable and adaptable method to optimize vessel performance under all operating conditions.

### SUMMARY OF THE INVENTION

The invention disclosed herein provides an air layer drag reduction system nozzle assembly. The air layer drag reduction system nozzle assembly includes a sea chest having an open cavity therein, wherein the sea chest includes a gas flow inlet, and an open lower boundary configured to receive a flow guiding nozzle flap. The nozzle assembly further includes a flow guiding nozzle flap. The flap is configured to guide a direction and flow rate of a gaseous flow. The sea chest has at least one longitudinal engagement area, wherein the at least one longitudinal engagement area is a rigidly fixed semi-circumferential bracket for mounting the flow guiding nozzle flap. The rigidly fixed semi-circumferential bracket is affixed at least semi-circumferentially at a border of the open lower boundary. The at least one longitudinal engagement area includes a removably affixed at least semi-circumferential fitting frame. The nozzle assembly yet further provides a flow guiding nozzle flap is coupled to the at least one longitudinal engagement area, wherein the flow guiding nozzle flap is coupled to the at least one longitudinal engagement area by the fitting frame. The air layer drag reduction system nozzle assembly is operable in a submerged environment.

The invention disclosed herein also provides an air layer drag reduction nozzle insert. The air layer drag reduction nozzle insert includes a fitting frame configured to be removably affixed within an open lower boundary of a sea chest, a flow guiding nozzle flap positioned within the opening of the fitting frame, and a hinge connection coupling a forward edge of the flow guiding nozzle flap to an inner surface of a forward portion of the fitting frame along a lateral axis extending between a port side and a starboard side of the fitting frame. The fitting frame has an outer surface configured to conform to a complementary geometry of the open lower boundary and an inner surface defining an opening. The flow guiding nozzle flap is rotatable about the lateral axis between a closed position and an open position.

Further disclosed, herein, is a method for retrofitting a marine vessel with an air layer drag reduction nozzle insert. The method comprises providing a nozzle insert. The nozzle insert comprises a fitting frame configured to be removably affixed within an open lower boundary of a sea chest, a flow guiding nozzle flap positioned within the opening of the fitting frame, and a hinge connection coupling a forward edge of the flow guiding nozzle flap to an inner surface of a forward portion of the fitting frame along a lateral axis extending between a port side and a starboard side of the fitting frame. The fitting frame has an outer surface configured to conform to a complementary geometry of the open lower boundary and an inner surface defining an opening. The flow guiding nozzle flap is rotatable about the lateral axis between a closed position and an open position.

It is an object of the present invention to provide an air layer drag reduction nozzle retrofit that minimizes drag when the air layer drag reduction system is inactive by integrating a securement plate that sits flush with the hull and a rotatable nozzle flap that seals the system when not in use.

It is yet another object of the present invention is to enable the retrofitting of existing air lubrication systems by providing a fitting frame as a securement plate that recesses into an existing sea chest cavity and allows for the installation of a rotatable nozzle flap without requiring significant modifications to the vessel's structure.

It is a further object to improve air distribution efficiency when the system is active by incorporating a nozzle flap with a concave curvature that directs airflow in an axial direction parallel to the hull, optimizing air lubrication performance.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a cross-sectional view of a simplified conceptual illustration of an existing sea chest with retrofit nozzle flap installed.

FIG. 2 illustrates a bottom isometric view of a simplified conceptual illustration of a sea chest with nozzle face removed.

FIG. 3A illustrates a bottom isometric view of a simplified conceptual illustration of the sea chest with retrofit nozzle flap installed, with the flap in a closed position.

FIG. 3B illustrates a bottom isometric view of a simplified conceptual illustration of the sea chest with retrofit nozzle flap installed, with the flap in a descended position.

FIG. 4 illustrates a system schematic view of the air layer drag reduction system.

FIG. 5 illustrates a top front isometric view of a nozzle flap and fitting frame.

FIG. 6 illustrates a top front isometric view of an embodiment of a sea chest of an air layer drag reduction system.

FIG. 7 illustrates a top front isometric view of the nozzle assembly for the air layer drag reduction system, with sea chest boundary shown in dashed lines.

FIG. 8 illustrates a bottom view of the sea chest with nozzle assembly shown installed therein.

FIG. 9A illustrates a front elevation view of the nozzle flap installed in a sea chest, wherein the sidewalls of the sea chest are shown in dashed lines.

FIG. 9B illustrates a rear elevation view of the nozzle flap installed in a sea chest, wherein the sidewalls of the sea chest are shown in dashed lines.

FIG. 9C illustrates a rear elevation view of the nozzle flap installed in a sea chest.

FIG. 10A illustrates a side elevation view of the sea chest with nozzle in an open state, wherein the boundary of the sea chest is shown in dashed lines.

FIG. 10B illustrates a cross-section view of the sea chest with nozzle in an open state, wherein the boundary of the sea chest is shown in dashed lines.

FIG. 11A illustrates a front elevation view of the nozzle flap and fitting frame in a closed state.

FIG. 11B illustrates a rear elevation view of the nozzle flap and fitting frame in a closed state.

FIG. 12A illustrates a front elevation view of the nozzle flap and fitting frame in an open state.

FIG. 12B illustrates a rear elevation view of the nozzle flap and fitting frame in an open state.

FIG. 13A illustrates a side elevation view of the nozzle flap and fitting frame in an closed state.

FIG. 13B illustrates a side elevation view of the nozzle flap and fitting frame in an open state.

FIG. 14 illustrates a bottom view of the nozzle flap and fitting frame.

FIG. 15 illustrates a top view of the nozzle flap and fitting frame.

FIG. 16 illustrates a rear top isometric view of the nozzle flap.

FIG. 17A illustrates a top view of the nozzle flap and fitting frame with angulated flow channels.

FIG. 17B illustrates a top front isometric view of the nozzle flap and fitting frame with angulated flow channels in a closed state.

FIG. 17C illustrates a top front isometric view of the nozzle flap and fitting frame with angulated flow channels in an open state.

FIG. 18A illustrates a bottom rear isometric exploded view of the assembly with sea chest, fitting frame, nozzle flap and securement mechanisms, representative of a retrofit.

FIG. 18B illustrates a bottom rear isometric partially-exploded view of the assembly with sea chest with fitting frame nozzle flap recessed up into the sea chest, and securement mechanisms shown pre-install.

FIGS. 19A-19b illustrate isometric views of the bolt cap.

FIGS. 20A-20C illustrate views of the anti-compression washer.

FIGS. 21A-21B illustrates removal steps from a retrofit installation of an embodiment of an ALS system.

FIGS. 22A-22B illustrates removal steps from a retrofit installation of an additional embodiment of an ALS system.

FIGS. 23A-23B illustrates install steps from a retrofit installation of the embodiments of an ALS system shown in FIGS. 21A-22B.

FIGS. 24A-24C illustrate a retrofit embodiment for round-open lower boundary applications.

FIGS. 25A-25C illustrate an additional retrofit embodiment for round-open lower boundary applications.

FIG. 26 illustrates a flow diagram of the method for retrofitting a marine vessel with an air layer drag reduction nozzle insert.

### DETAILED DESCRIPTION OF THE INVENTION

Air lubrication systems are an increasingly important technology in the maritime industry, aiming to improve fuel efficiency by reducing drag on a vessel's hull. These systems work by injecting air beneath the hull to create a thin layer of gas, known as an air plastron, which reduces friction between the ship and surrounding water. However, despite advancements in air lubrication technologies, significant inefficiencies remain, particularly with how air is introduced and controlled as it exits nozzles onto the hull surface. Traditional nozzle designs often result in turbulent airflow, excessive air loss, and uneven distribution, which ultimately diminish the effectiveness of the system.

In previous air lubrication systems, air is typically injected through chambered openings in the hull or via external air belts attached to the ship's bottom. While these methods can introduce air to the hull surface, they also have major drawbacks. First, they often create significant turbulence at the air-water interface, leading to energy losses that reduce overall efficiency. Second, when the system is off, these nozzles remain open, allowing water to flood the system and generate drag, which negates potential efficiency gains. Lastly, these nozzles do not offer directional control of the air as it exits, meaning a large portion of the injected air dissipates inefficiently rather than forming a stable air layer along the hull.

In our previously disclosed invention (see: U.S. patent application Ser. No. 18/219,375, entitled “A System and Method for Delivering Air to a Submerged Ship Surface), a solution was introduced that recesses an air injection cavity (or “sea chest”) within the hull and incorporates a closable flap to prevent drag when the system is inactive. This approach represented a significant improvement over traditional nozzle grates, but further refinement was needed to optimize airflow and reduce turbulence as air exits the system. Specifically, when air is simply injected into an open cubic cavity, it bounces around in unpredictable directions, creating randomized turbulence and preventing the formation of a smooth, energy-efficient air layer.

The present invention improves upon these prior systems by introducing a vectored air layer drag reduction nozzle with an aerodynamically enhanced flap system. The flap includes a concave upper surface, which redirects and guides the airflow in a controlled rearward direction. This design applies principles of flow vectoring applications, where airflow is smoothly transitioned to prevent turbulent eddies. Instead of air being injected chaotically into the cavity and exiting at inefficient angles, the concave flap surface curves the airflow gently downward and rearward, ensuring that air adheres to the hull rather than dispersing unpredictably.

Because the air is directionally delivered below the hull of the ship, a thin continuous layer of air is present rather than a micro-bubble cloud as in early air lubrication systems. Therefore, the current system falls under the class of an air layer drag reduction system. Air layer drag reduction (ALDR) systems represent a more advanced approach in which a substantially continuous air film or plastron is maintained beneath portions of the vessel hull. When properly established, this thin air layer separates the hull surface from direct contact with water, dramatically reducing skin-friction drag relative to bubble-based ALS methods. However, maintaining such a continuous air layer requires careful control of the water-air interface so that water does not collapse the air film. In practice, this requires that the local water flow be displaced slightly below the hull surface so that injected air can spread laterally and remain attached along the hull.

A key innovation of this system is that it balances aerodynamic and hydrodynamic pressures to improve efficiency. The vectored flap ensures that air exits in alignment with the natural water flow under the hull, preventing disruptive interactions between the injected air and the surrounding water. This results in a smoother air-water interface, which reduces resistance and improves the longevity of the air plastron. Additionally, by minimizing turbulence at the nozzle exit, the system reduces unnecessary energy expenditure, further enhancing fuel efficiency.

In addition to improving airflow vectoring, the disclosed system also includes passive closure enhancements. The flap is designed to automatically close when air is not being injected, using a combination of buoyancy forces, flap weight, and hydrodynamic pressure. Unlike traditional systems where open nozzles create unnecessary drag when not in use, this self-sealing design eliminates parasitic resistance, further optimizing fuel savings. The system may also include a counterweight to further assist in closure. While some embodiments rely solely on the buoyancy of the flap and hydrodynamic pressure, the counterweight can also serve as a sacrificial anode, rather than anodes disrupting the gaseous flow in the sea chest. The anode can have flow channels to further guide the gaseous flow through the flow channels of the flap.

In our previous patent applications, including U.S. patent application Ser. No. 18/219,375, entitled “A System and Method for Delivering Air to a Submerged Ship Surface”, we disclosed a fundamental air lubrication system (also falling into the category of air layer drag reduction nozzles) featuring a recessed cavity, or sea chest, with a closable flap. This design allowed the cavity to remain sealed during forward motion when the system was inactive, effectively eliminating unnecessary drag. While this was a significant improvement over conventional systems, further refinements were needed to enhance air distribution and minimize turbulence at the air-water interface. Specifically, the system required precise directional control of the exiting air to ensure an optimal laminar flow along the hull. Without such guidance, air could disperse chaotically, increasing turbulence and energy losses. Additionally, the flap needed to balance hydrodynamic and aerodynamic forces to ensure reliable closure when the system is off, preventing water ingress and unwanted drag.

The present invention addresses these challenges by introducing a precisely engineered nozzle flap system that enhances both energy efficiency and aerodynamic performance. At its core, the system features a flap with a concave aerodynamic curvature that guides the gaseous flow in a controlled rearward direction, ensuring smooth air distribution across the hull. This prevents turbulent interactions at the air-water interface, resulting in a more stable and effective air plastron that reduces frictional drag.

To provide even dispersion of the gaseous flow, several flow channels may be used. The sidewalls corral the flow into individual flows so that air is not stagnant in one spot while other areas are devoid of coverage.

A key aspect of this improvement is the creation of a uniform trailing edge, which provides a gentle transition between the water beneath the hull and the injected air. This transition minimizes turbulence, preventing the formation of eddies and vortices that could otherwise disrupt the air layer.

The results of these improvements are substantial. By optimizing air distribution, reducing turbulence, and ensuring a stable air layer, this system significantly increases energy efficiency compared to conventional air lubrication methods. Ships equipped with this system experience lower fuel consumption, reduced carbon emissions, and enhanced overall performance. Additionally, because the nozzle flap is modular and replaceable, the system allows for easy maintenance and upgrades, making it a highly adaptable solution for various ship designs.

The system is also enhanced for use in both new build and retrofit applications. The system is constructed with a fitting frame, which may be semi-circumferential or a full loop that allows the flap to affix to pre-existing cavities. Intermediary plates may also be used to further seal up the pre-existing cavity so that air only flows out of the flap location. While the longitudinal engagement is fixed, to the lower boundary of the sea chest, the longitudinal engagement area may have removable components to allow the modular construction.

The invention therefore provides a solution for the drag and inefficiencies caused by existing air lubrication systems when inactive. The invention includes a retrofit aspect, as disclosed above. The key is the use of a securement plate, known as the fitting frame, and a rotatable nozzle flap assembly designed to seamlessly integrate into an existing sea chest cavity. This retrofit solution eliminates additional resistance when air disbursement is off and optimizes airflow when the system is engaged.

As discussed above, existing air lubrication systems suffer from increased drag when not in use due to protruding nozzle components that disrupt the hull's smooth surface. Existing air lubrication systems also provide inconsistent performance in varying sea conditions, causing operators to turn them off, further negating efficiency gains. Additionally, current air lubrication systems are not easily retrofitted, making it costly and impractical to upgrade older vessels.

The present invention solves these problems by introducing a securement plate that recesses into the sea chest cavity, ensuring a flush transition with the vessel's hull. This removes drag-inducing elements when the air layer drag reduction system is inactive while providing a stable mounting structure for the nozzle flap assembly.

The nozzle flap assembly is positioned within the inner opening of the securement plate and is hinged along a lateral axis extending between the port and starboard sides of the opening. This hinge placement allows the flap to rotate between an open position for air layer drag reduction and a closed position that aligns with the hull to eliminate drag.

The system also includes a securement means, which affixes the retrofit assembly to the vessel, either by attaching the securement plate to the sea chest or securing it directly to the hull. This flexibility allows for easy installation across different vessel types without extensive modifications. Bolts may also be included to secure apertures in the securement plate to threaded holes complemental thread holes in the longitudinal engagement area. An anti-compression washer may also be utilized to avoid damage from overtightening the bolts. In order to avoid drag from the bolts and bolt holes, caps can be included to cover the bolts and provide a smooth surface.

The retrofit process involves removing an existing sea chest cover (if present), installing the securement plate flush with the hull, and ensuring the nozzle flap assembly is properly positioned within the inner opening. Once installed, the flap operates seamlessly between its open and closed positions, reducing drag when inactive and optimizing air layer drag reduction when engaged.

This invention offers a cost-effective solution for upgrading existing air lubrication systems, allowing vessels to achieve fuel savings and hydrodynamic improvements without major structural overhauls. By eliminating drag when the system is inactive and enhancing airflow efficiency when in use, this retrofit design addresses two major limitations of conventional air lubrication technology.

Furthermore, the ability to retrofit rather than replace existing systems makes this invention a scalable solution for both new and old vessels, promoting sustainability and operational efficiency in modern maritime applications.

The invention described herein provides a significant advancement in air lubrication technology, ensuring that vessels can operate with consistent fuel savings and enhanced performance across various sea conditions.

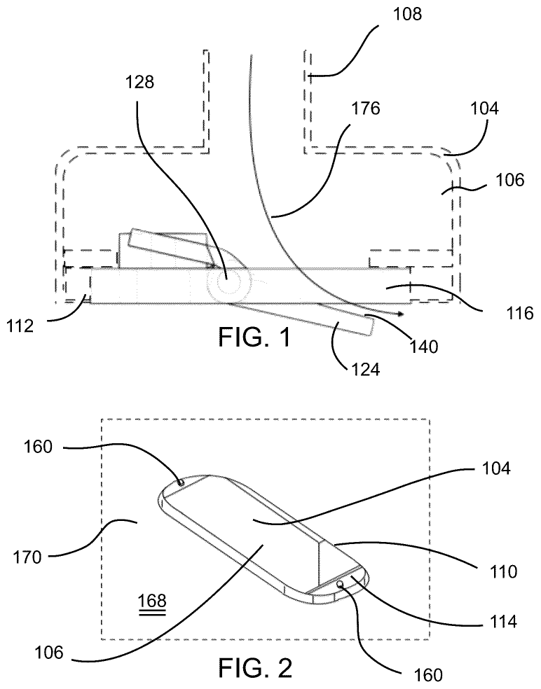

The air layer drag reduction nozzle plate and flap of the present invention may be used to provide an air lubrication nozzle retrofit that minimizes drag when the system is inactive by integrating a securement plate that sits flush with the hull and a rotatable nozzle flap that seals the system when not in use, to enable the retrofitting of existing air lubrication systems by providing a securement plate that recesses into an existing sea chest cavity and allows for the installation of a rotatable nozzle flap without requiring significant modifications to the vessel's structure, and to improve air distribution efficiency when the system is active by incorporating a nozzle flap with a concave curvature that directs airflow in an axial direction parallel to the hull, optimizing air layer drag reduction performance. This system, apparatus, and method are particularly shown in FIGS. 1-26.

FIG. 1 illustrates a cross-sectional view of a simplified conceptual representation of an air layer drag reduction system nozzle assembly 102 installed within a sea chest 104 of a marine vessel hull 170. The sea chest 104 includes an open cavity 106 and a gas flow inlet 108 through which a gaseous flow 176 may enter the sea chest 104. The sea chest 104 further includes an open lower boundary 110 positioned generally flush with an exterior hull surface 168. A longitudinal engagement area 112 is positioned along the border of the open lower boundary 110 and may include a rigidly fixed semi-circumferential bracket 114. A fitting frame 116 is removably affixed to the longitudinal engagement area 112 and supports a flow guiding nozzle flap 124. The nozzle flap 124 is coupled to the fitting frame 116 by a hinge connection 128, allowing the nozzle flap 124 to rotate relative to the fitting frame 116. In some embodiments, the nozzle flap 124 includes a concave top surface 140 configured to guide gaseous flow 176 exiting the sea chest 104 in a direction substantially parallel to the exterior hull surface 168.

FIG. 2 illustrates a bottom isometric view of a simplified conceptual illustration of a sea chest 104 with a nozzle face removed. The sea chest 104 is positioned within a marine vessel hull 170 and includes an open cavity 106 configured to receive gaseous flow from an associated air layer drag reduction system. The sea chest 104 further includes an open lower boundary 110 through which gaseous flow may exit toward the exterior hull surface 168 when a nozzle is installed. Along the border of the open lower boundary 110, a longitudinal engagement area may include a semi-circumferential bracket 114 configured to support mounting components of the nozzle assembly. In some embodiments, the bracket 114 includes threaded apertures 160 configured to receive mounting bolts for securing a fitting frame and associated nozzle flap assembly within the open lower boundary 110 of the sea chest 104.

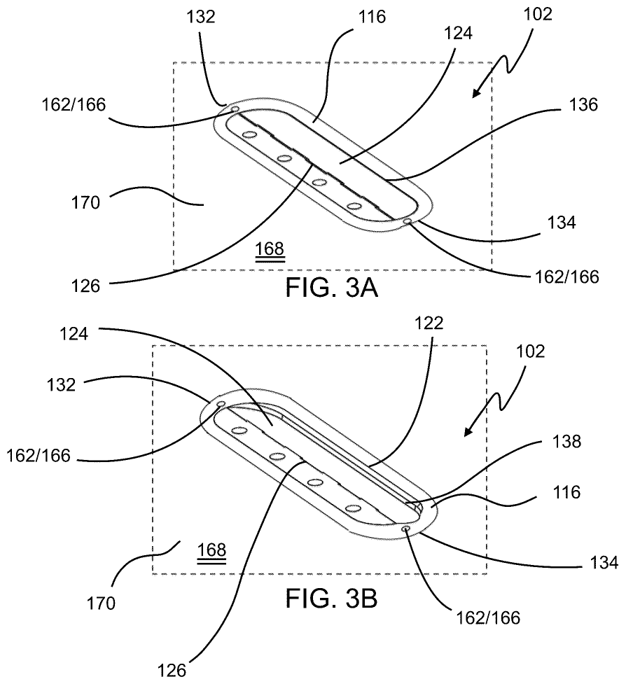

FIG. 3A illustrates a bottom isometric view of a simplified conceptual illustration of the sea chest with a retrofit nozzle insert assembly installed, with the flow guiding nozzle flap 124 shown in a closed position 136. The nozzle insert assembly includes a fitting frame 116 supporting the flow guiding nozzle flap 124. The flow guiding nozzle flap 124 includes a forward edge 126 and extends between a port side 132 and a starboard side 134 of the fitting frame 116. In the closed position 136, the flow guiding nozzle flap 124 is positioned substantially flush with an exterior hull surface 168 of a marine vessel hull 170, thereby minimizing hydrodynamic drag when the air layer drag reduction system nozzle assembly 102 is inactive. In some embodiments, mounting bolts 162 may be used to secure the assembly, and bolt covers 166 may be positioned over the mounting bolts 162 to provide a smooth external surface along the exterior hull surface 168.

FIG. 3B illustrates a bottom isometric view of a simplified conceptual illustration of the sea chest with the retrofit nozzle insert assembly 174 installed, with the flow guiding nozzle flap 124 shown in a descended open position 138. The flow guiding nozzle flap 124 extends between a port side 132 and a starboard side 134 of the fitting frame 116 and includes a forward edge 126. In the open position 138, the flow guiding nozzle flap 124 is displaced downward relative to the exterior hull surface 168 of the marine vessel hull 170, allowing the flow guiding nozzle flap 124 to direct gaseous flow during operation of the air layer drag reduction system nozzle assembly 102. In some embodiments, mounting bolts 162 and associated bolt covers 166 may be used to secure the nozzle insert assembly 174 within the sea chest structure while maintaining a smooth exterior profile along the exterior hull surface 168.

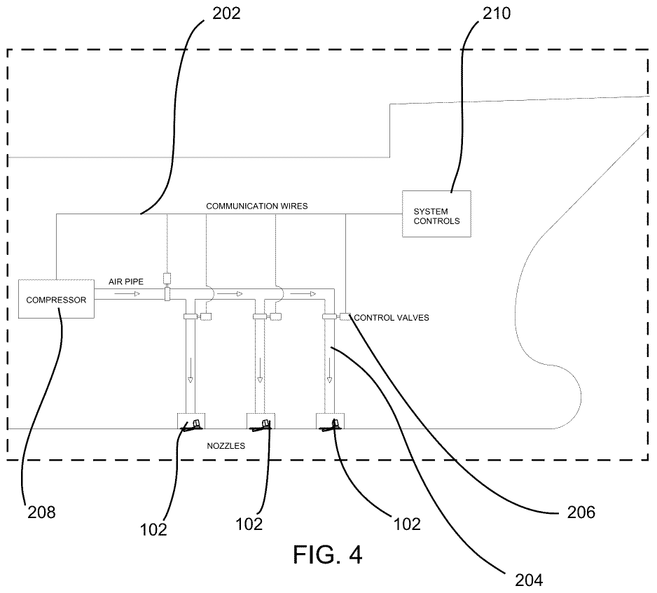

FIG. 4 illustrates a system schematic view of the air layer drag reduction system 102. In some embodiments, the system 102 includes a compressor 208 configured to supply pressurized air through an air pipe 204 to the sea chest 104. A control valve 206 may regulate the delivery of air into the sea chest 104, and a control system 210 may control operation of the compressor 208 and the control valve 206. Communication wires 202 may couple the control system 210 with the compressor 208 and the control valve 206 to coordinate operation of the air layer drag reduction system 102. In operation, the system 102 provides gaseous flow to the sea chest 104 for distribution beneath the marine vessel hull as part of the air layer drag reduction process.

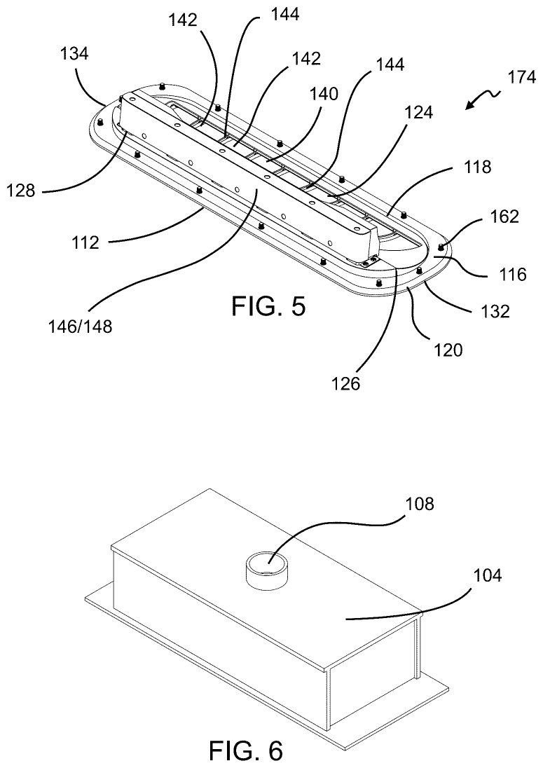

FIG. 5 illustrates a top front isometric view of a nozzle insert assembly 174 including a fitting frame 116 and a flow guiding nozzle flap 124. The fitting frame 116 includes an outer surface 120 and an inner surface 118 defining an opening within which the flow guiding nozzle flap 124 is positioned. The flow guiding nozzle flap 124 includes a forward edge 126 and extends between a port side 132 and a starboard side 134 of the fitting frame 116. A hinge connection 128 couples the forward edge 126 of the flow guiding nozzle flap 124 to the fitting frame 116, allowing the flow guiding nozzle flap 124 to rotate relative to the fitting frame 116. In some embodiments, the flow guiding nozzle flap 124 includes a concave top surface 140 and a plurality of flow channels 142 defined by upward protrusions 144 configured to guide gaseous flow through the nozzle insert assembly 174. Mounting bolts 162 may be used to secure the nozzle insert assembly 174 to a longitudinal engagement area 112. In some embodiments, a removable counterweight 146 may also be provided, and in certain embodiments the counterweight may comprise a sacrificial anode 148.

FIG. 6 illustrates a top front isometric view of an embodiment of a sea chest 104 of an air layer drag reduction system. The sea chest 104 is shown from an external perspective and includes a gas flow inlet 108 configured to deliver gaseous flow into the interior of the sea chest during operation of the system.

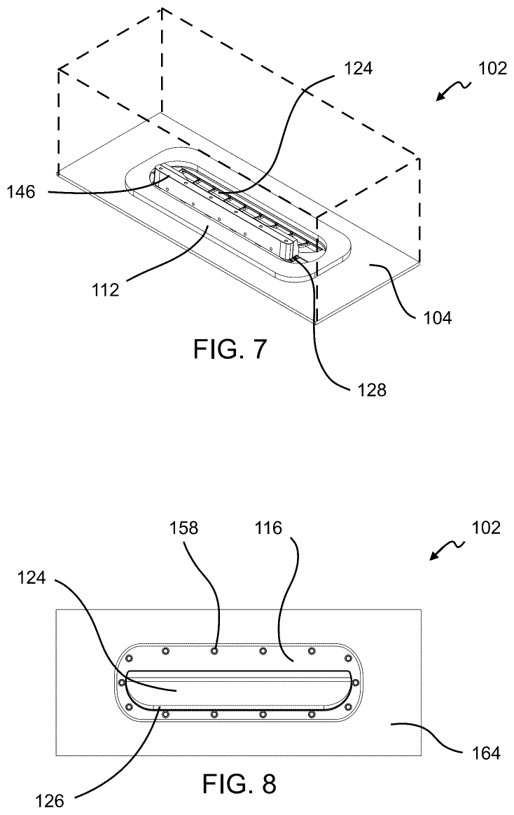

FIG. 7 illustrates a top front isometric view of the air layer drag reduction system nozzle assembly 102 with the boundary of the sea chest 104 shown in dashed lines for reference. The nozzle assembly includes a flow guiding nozzle flap 124 coupled to a longitudinal engagement area 112 by a hinge connection 128. In some embodiments, the flow guiding nozzle flap 124 may include a removable counterweight 146 configured to bias the flow guiding nozzle flap 124 toward a closed position when the air layer drag reduction system nozzle assembly 102 is inactive.

FIG. 8 illustrates a bottom view of the air layer drag reduction system nozzle assembly 102 shown installed within a sea chest 104. The assembly includes a fitting frame 116 supporting a flow guiding nozzle flap 124. The flow guiding nozzle flap 124 includes a forward edge 126 oriented toward a forward portion of the assembly. The fitting frame 116 further includes a plurality of apertures 158 configured to receive mounting hardware for securing the assembly within the sea chest 104.

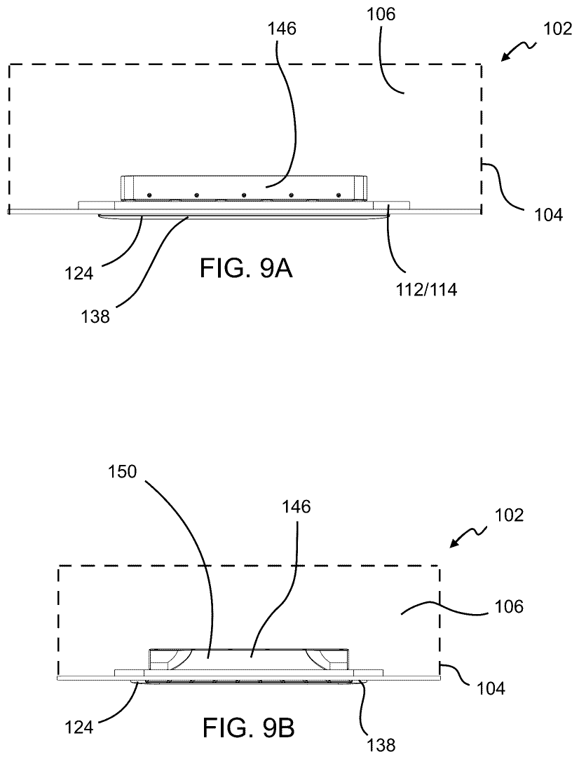

FIG. 9A illustrates a front elevation view of the air layer drag reduction system nozzle assembly 102 with the boundaries of the sea chest 104 shown in dashed lines. The sea chest 104 includes an open cavity 106 within which the nozzle insert 174 is positioned. The nozzle insert 174 is supported by a longitudinal engagement area 112, which may include a semi-circumferential bracket 114 configured to mount the assembly insert components. The flow guiding nozzle flap 124 is shown in an open position 138 relative to the sea chest 104. In some embodiments, the flow guiding nozzle flap 124 may include a removable counterweight 146. The counterweight 146 may further include one or more flow channels 150 configured to guide gaseous flow passing through the assembly 102.

FIG. 9B illustrates a rear elevation view of the air layer drag reduction system nozzle assembly 102 with the boundaries of the sea chest 104 shown in dashed lines. The sea chest 104 includes an open cavity 106 within which the nozzle assembly 102 is positioned. The flow guiding nozzle flap 124 is shown in an open position 138 relative to the sea chest 104. In some embodiments, the flow guiding nozzle flap 124 may include a removable counterweight 146, and the counterweight 146 may include one or more flow channels 150 configured to guide gaseous flow through the nozzle assembly 102.

FIG. 9C illustrates a rear elevation view of the air layer drag reduction system nozzle assembly 102. The nozzle flap 124 is shown installed within a sea chest 104. The sea chest 104 includes a gas flow inlet 108 configured to deliver gaseous flow into the sea chest during operation of the system. The flow guiding nozzle flap 124 is shown in an open position 138 relative to the sea chest 104.

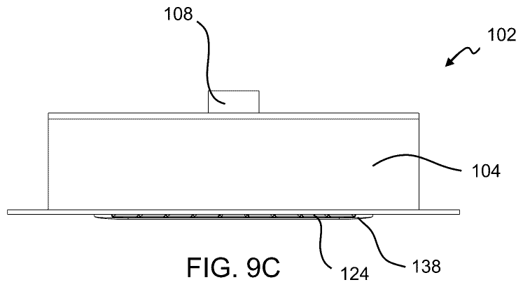

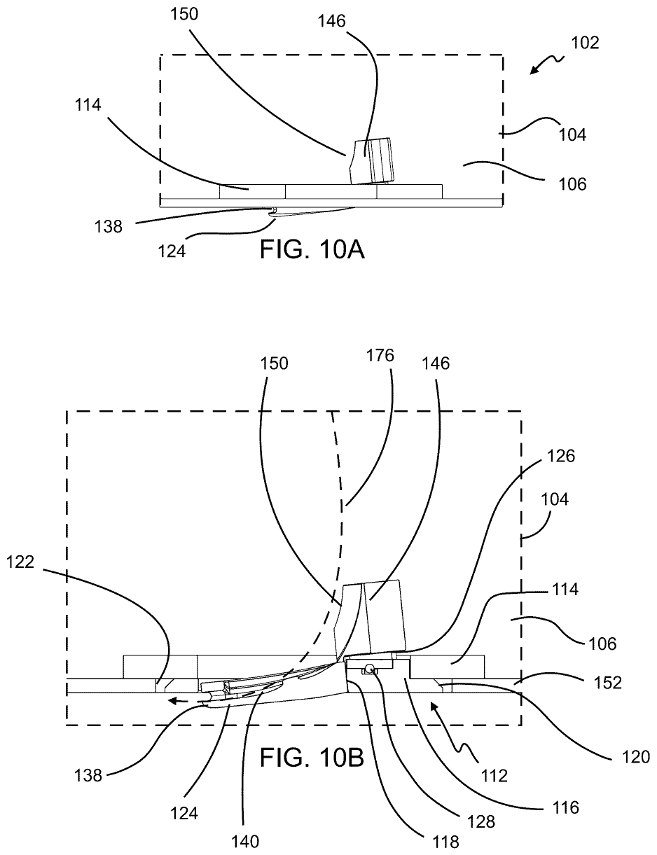

FIG. 10A illustrates a side elevation view of an air layer drag reduction system nozzle assembly 102 with the boundary of the sea chest 104 shown in dashed lines. The sea chest 104 includes an open cavity 106. A semi-circumferential bracket 114 may be positioned along the sea chest 104 to support components of the nozzle assembly. A flow guiding nozzle flap 124 is shown in an open position 138 relative to the sea chest 104. In some embodiments, the flow guiding nozzle flap 124 may include a removable counterweight 146, and the counterweight 146 may include one or more flow channels 150 configured to guide gaseous flow during operation of the nozzle assembly 102.

FIG. 10B illustrates a cross-sectional view of the air layer drag reduction system nozzle assembly 102. This cross-sectional view allows the reader to appreciate the various components that make up the longitudinal engagement area 112 and how the components interact with one another. In the illustrated embodiment, a flow guiding nozzle flap 124 is coupled to a fitting frame 116 by a hinge connection 128 positioned near a forward edge 126 of the flap 124. The fitting frame 116 includes an inner surface 118 and an outer surface 120 defining an opening 122 within which the flow guiding nozzle flap 124 is positioned. In some embodiments, the fitting frame 116 interfaces with an intermediary plate 152 positioned within the sea chest cavity 106 and supported by a semi-circumferential bracket 114. The flow guiding nozzle flap 124 is shown in an open position 138. In some embodiments, the flow guiding nozzle flap 124 may include a removable counterweight 146 having one or more flow channels 150. The cross-sectional view further illustrates a gaseous flow path 176 and how the flow path 176 is influenced by the curvature of the flow channels 150 of the counterweight 146 and a concave surface 140 of the flow guiding nozzle flap 124, thereby directing the gaseous flow path 176 generally parallel to the hull surface.

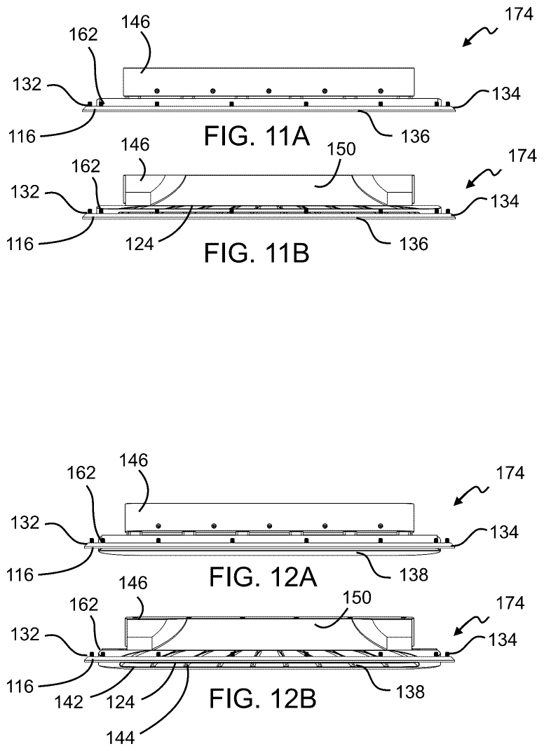

FIG. 11A illustrates a bottom isometric view of a nozzle insert assembly 174 including a fitting frame 116 and a flow guiding nozzle flap positioned between a port side 132 and a starboard side 134 of the fitting frame 116. In the illustrated embodiment, the flow guiding nozzle flap is shown in a closed position 136 relative to the fitting frame 116. The nozzle insert assembly 174 may further include mounting bolts 162 configured to secure the fitting frame 116 to a supporting structure. In some embodiments, the flow guiding nozzle flap may include a removable counterweight 146 configured to bias the

### Flap Toward the Closed Position 136.

FIG. 11B illustrates a rear elevation view of the nozzle insert assembly 174 including the fitting frame 116 and the flow guiding nozzle flap 124 in a closed position 136. The flow guiding nozzle flap 124 extends between a port side 132 and a starboard side 134 of the fitting frame 116. In some embodiments, mounting bolts 162 may be used to secure the fitting frame 116 to a supporting structure. The flow guiding nozzle flap 124 may further include a removable counterweight 146 positioned along an upper region of the flap 124. In some embodiments, the counterweight 146 may include one or more flow channels 150 configured to influence gaseous flow when the flow guiding nozzle flap 124 transitions between open 138 and closed 138 positions.

FIG. 12A illustrates a front elevation view of the nozzle insert assembly 174 including the fitting frame 116 and the flow guiding nozzle flap 124 in an open position 138. The flow guiding nozzle flap 124 extends between a port side 132 and a starboard side 134 of the fitting frame 116. In some embodiments, mounting bolts 162 may be used to secure the fitting frame 116 to a supporting structure. The flow guiding nozzle flap 124 may further include a removable counterweight 146 configured to influence movement of the flap 124 when transitioning between open 138 and closed 136 positions.

FIG. 12B illustrates a rear elevation view of the nozzle insert assembly 174 including the fitting frame 116 and the flow guiding nozzle flap 124 in an open position 138. The flow guiding nozzle flap 124 extends between a port side 132 and a starboard side 134 of the fitting frame 116. In the illustrated embodiment, the flow guiding nozzle flap 124 includes a plurality of flow channels 142 separated by upward protrusions 144 configured to guide gaseous flow through the nozzle insert assembly 174. In some embodiments, mounting bolts 162 may be used to secure the fitting frame 116 to a supporting structure. The flow guiding nozzle flap 124 may further include a counterweight 146, and the counterweight 146 may include one or more flow channels 150 configured to influence gaseous flow exiting the nozzle insert assembly 174.

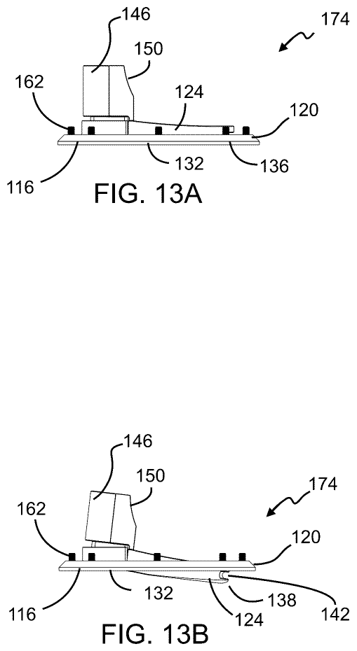

FIG. 13A illustrates a side elevation view of the nozzle insert assembly 174 including the fitting frame 116 and the flow guiding nozzle flap 124 in a closed position 136. The fitting frame 116 includes an outer surface 120 and extends toward a port side 132, and may be secured by mounting bolts 162, while the flow guiding nozzle flap 124 may include a counterweight 146 having one or more flow channels 150.

FIG. 13B illustrates a side elevation view of the nozzle flap and fitting frame in an open state. The view shows the flow guiding nozzle flap 124 in an open position 138 relative to the fitting frame.

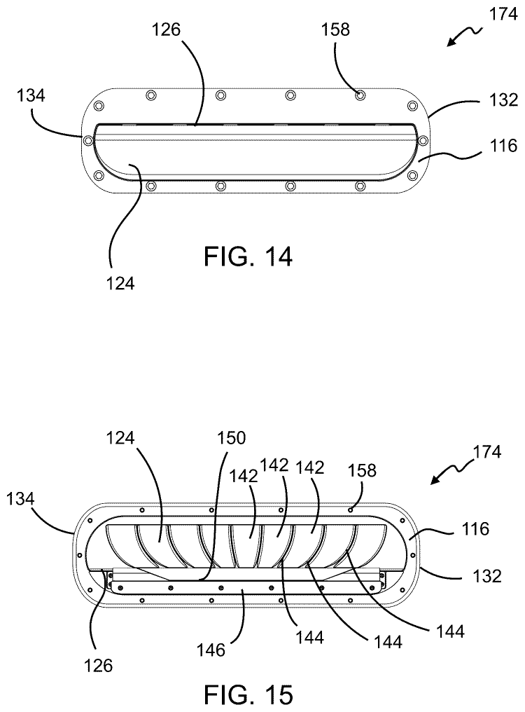

FIG. 14 illustrates a bottom view of the nozzle insert assembly 174 including the fitting frame 116 and the flow guiding nozzle flap 124. The flow guiding nozzle flap 124 extends between a port side 132 and a starboard side 134 of the fitting frame 116 and includes a forward edge 126. The fitting frame 116 further includes a plurality of apertures 158 configured to receive mounting hardware.

FIG. 15 illustrates a top view of the nozzle insert assembly 174 including the fitting frame 116 and the flow guiding nozzle flap 124. The flow guiding nozzle flap 124 extends between a port side 132 and a starboard side 134 of the fitting frame 116 and includes a forward edge 126. In some embodiments, the flow guiding nozzle flap 124 includes a plurality of flow channels 142 defined by upward protrusions 144. The flow guiding nozzle flap 124 may further include a counterweight 146 having one or more flow channels 150. The fitting frame 116 may also include apertures 158 configured to receive mounting hardware.

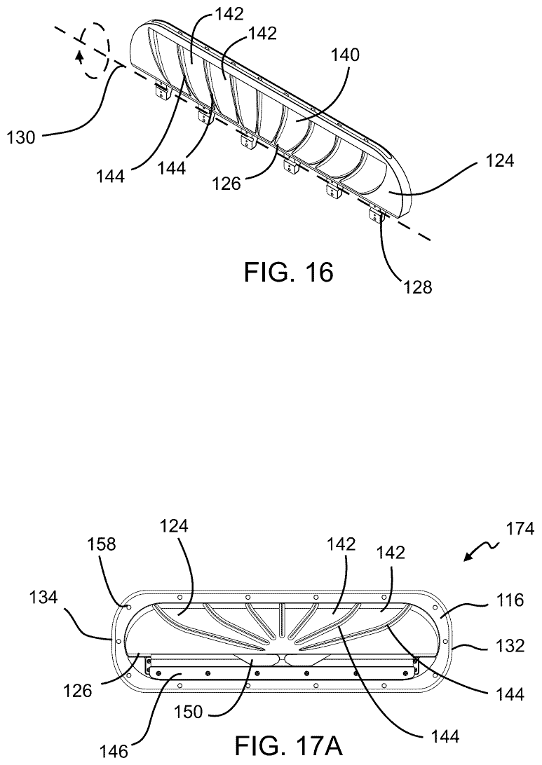

FIG. 16 illustrates a rear top isometric view of the flow guiding nozzle flap 124. The flow guiding nozzle flap 124 includes a forward edge 126 coupled to a hinge connection 128 along a lateral axis 130. In the illustrated embodiment, the flow guiding nozzle flap 124 includes a concave top surface 140 and a plurality of flow channels 142 defined by upward protrusions 144.

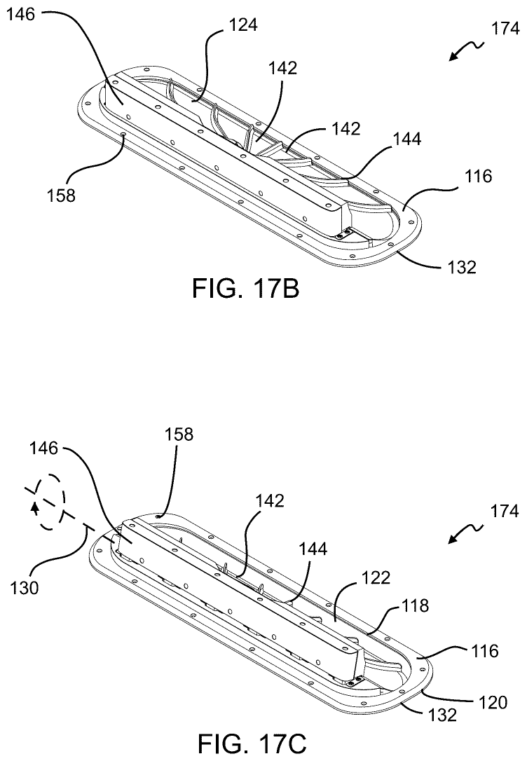

FIG. 17A illustrates a top view of the nozzle insert assembly 174 including the fitting frame 116 and the flow guiding nozzle flap 124 with angulated flow channels. The flow guiding nozzle flap 124 extends between a port side 132 and a starboard side 134 of the fitting frame 116 and includes a forward edge 126. In the illustrated embodiment, the flow guiding nozzle flap 124 includes a plurality of flow channels 142 defined by upward protrusions 144. The flow guiding nozzle flap 124 may further include a removable counterweight 146 having multiple flow channels 150, wherein the illustration shows two symmetrical channels. The fitting frame 116 may also include apertures 158 configured to receive mounting hardware.

FIG. 17B illustrates a top front isometric view of the nozzle insert assembly 174 including the fitting frame 116 and the flow guiding nozzle flap 124 with angulated flow channels, corresponding to the embodiment shown in FIG. 17A, with the flow guiding nozzle flap 124 shown in a closed state. The flow guiding nozzle flap 124 extends toward a port side 132 of the fitting frame 116 and includes a plurality of flow channels 142 defined by upward protrusions 144. In some embodiments, the flow guiding nozzle flap 124 may further include a removable counterweight 146. The fitting frame 116 may also include apertures 158 configured to receive mounting hardware.

FIG. 17C illustrates a top front isometric view of the nozzle insert assembly 174 including the fitting frame 116 and the flow guiding nozzle flap with angulated flow channels in an open state, corresponding to the embodiment shown in FIGS. 17A and 17B. The fitting frame 116 includes an outer surface 120 and an inner surface 118 defining an opening 122. In the illustrated embodiment, the flow guiding nozzle flap includes a plurality of flow channels 142 defined by upward protrusions 144. The nozzle insert assembly 174 may further include a removable counterweight 146 and apertures 158 configured to receive mounting hardware. A hinge connection may be positioned along a lateral axis 130 to allow the flow guiding nozzle flap to rotate relative to the fitting frame 116.

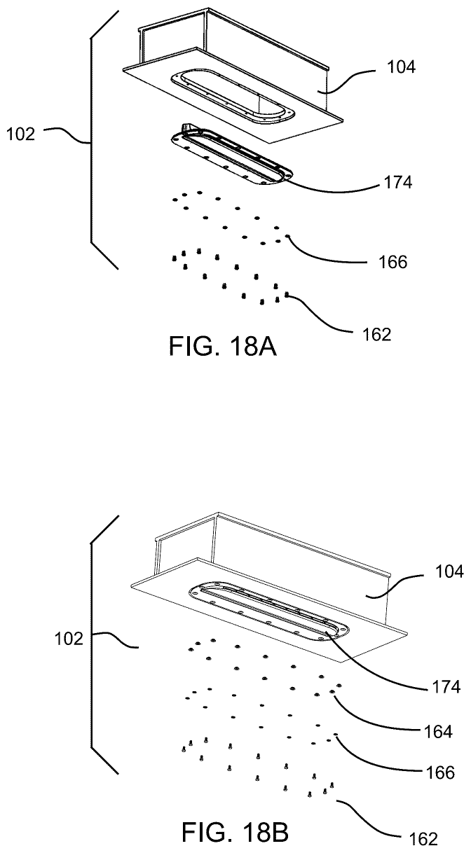

FIG. 18A illustrates a bottom rear isometric exploded view of the air layer drag reduction system nozzle assembly 102 including a sea chest 104 and a nozzle insert assembly 174, representative of a retrofit installation. The exploded view further illustrates mounting bolts 162 and bolt covers 166 configured to secure the nozzle insert assembly 174 relative to the sea chest 104.

FIG. 18B illustrates a bottom rear isometric partially-exploded view of the air layer drag reduction system nozzle assembly 102 including the sea chest 104 and the nozzle insert assembly 174 positioned within the sea chest 104. The figure further illustrates mounting bolts 162, anti-compression washers 164, and bolt covers 166 shown in a pre-installation arrangement for securing the nozzle insert assembly 174 relative to the sea chest 104.

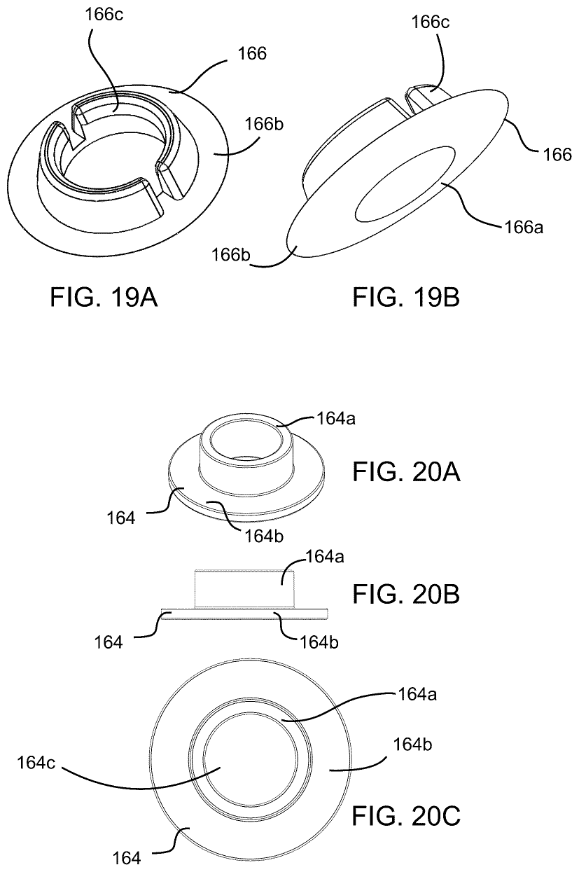

FIGS. 19A-19b illustrate isometric views of a bolt cover 166. FIG. 19A illustrates a top isometric view of the bolt cover 166 showing compression walls 166c configured to grip around the head of a mounting bolt, and side walls 166b extending from the bolt cover 166. FIG. 19B illustrates a bottom isometric view of the bolt cover 166 including a bottom surface 166a configured to form a smooth, substantially flush surface with the fitting frame when installed, thereby reducing hydrodynamic drag caused by exposed bolt heads.

FIGS. 20A-20C illustrate views of an anti-compression washer 164. FIG. 20A illustrates a top isometric view of the anti-compression washer 164 including a raised portion 164a extending upwardly from a base portion 164b. In some embodiments, the anti-compression washer 164 is configured to provide a buffer that limits excessive compression of the fitting frame during tightening of mounting bolts. FIG. 20B illustrates a side elevation view of the anti-compression washer 164 showing the raised portion 164a extending from the base portion 164b. FIG. 20C illustrates a top view of the anti-compression washer 164 including an aperture 164c formed through the washer body to receive a mounting bolt.

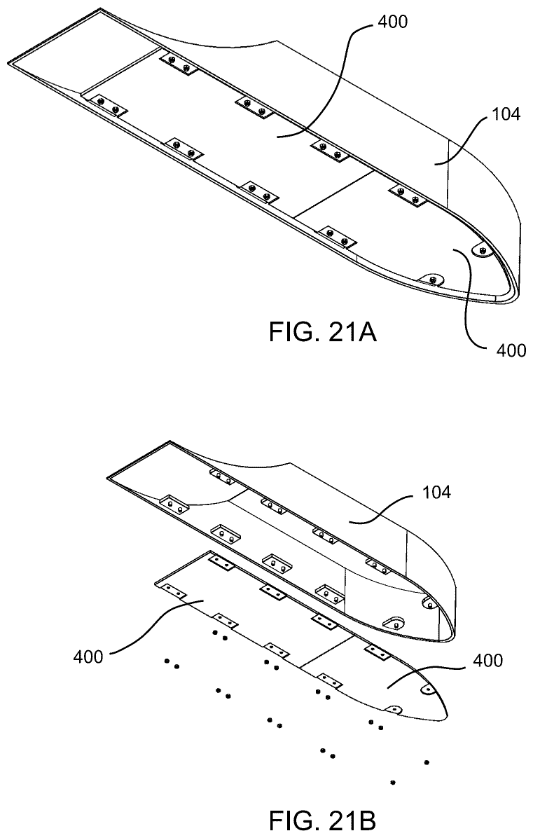

FIGS. 21A-21B illustrate removal steps associated with a retrofit installation of an embodiment of an air layer system. FIG. 21A illustrates a sea chest 104 with an existing cover plate 400 secured over the sea chest opening. In preparation for retrofit installation, the securing bolts may be removed from the cover plate 400. FIG. 21B illustrates the cover plate 400 removed from the sea chest 104, thereby exposing the interior cavity of the sea chest 104.

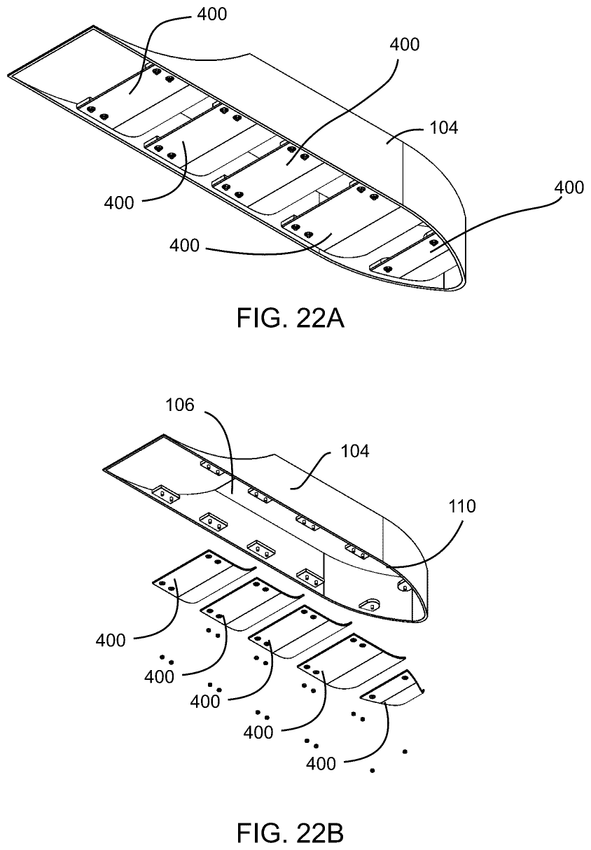

FIGS. 22A-22B illustrate removal steps from a retrofit installation of an additional embodiment of an air layer system. FIG. 22A illustrates a sea chest 104 including one or more existing cover plates 400 positioned over the sea chest opening. FIG. 22B illustrates the cover plates 400 removed from the sea chest 104, thereby exposing the interior cavity 106 within the sea chest 104. In some embodiments, the configuration of the sea chest 104 may include recessed space and openings that do not fully obstruct the cavity 106, allowing installation of a retrofit nozzle insert assembly 174 either after removal of the cover plates 400 or, in certain cases, by installing an intermediary plate over the existing plates while still providing access to the cavity 106.

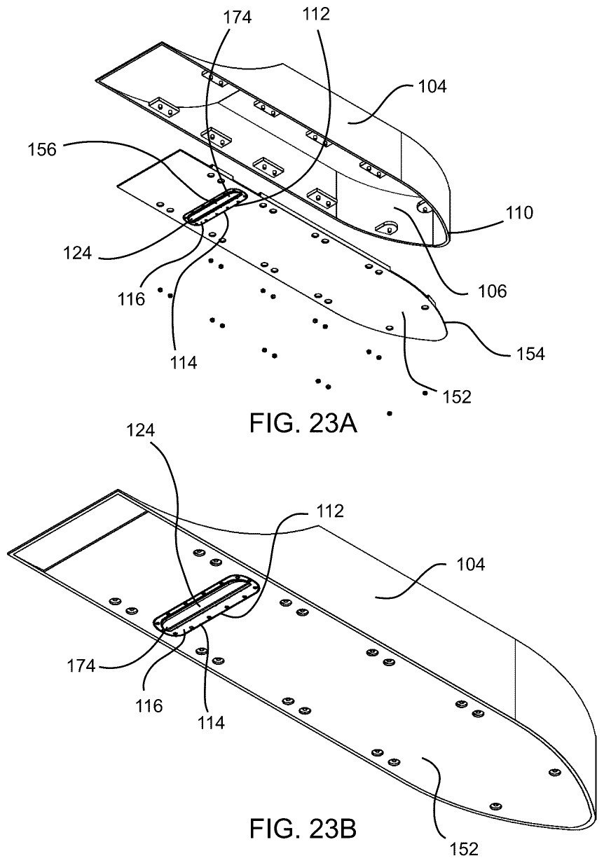

FIGS. 23A-23B illustrate installation steps for a retrofit installation of the embodiments of the air lubrication system shown in FIGS. 21A-22B. FIG. 23A illustrates an intermediary plate 152 and a nozzle insert assembly 174 positioned for installation within a sea chest 104. In the illustrated embodiment, the sea chest 104 includes a cavity 106 and an open lower boundary 110. A longitudinal engagement area 112 including a semi-circumferential bracket 114 is positioned along the border of the intermediary plate 152 which encloses the sea chest at the lower boundary 110. The intermediary plate 152 includes an outer boundary 154 complemental to the geometry of the open lower boundary 110 of the sea chest 104. An inner open periphery 156 and is configured to interface with the fitting frame 116. The nozzle insert assembly 174 includes a fitting frame 116 and a flow guiding nozzle flap 124 positioned within the opening of the fitting frame 116. Because the components are not yet installed, FIG. 23A may be viewed as a partially exploded representation of the retrofit components relative to the sea chest 104. FIG. 23B illustrates the completed installation with the intermediary plate 152 and the nozzle insert assembly 174 secured within the sea chest 104, with the flow guiding nozzle flap 124 supported by the fitting frame 116.

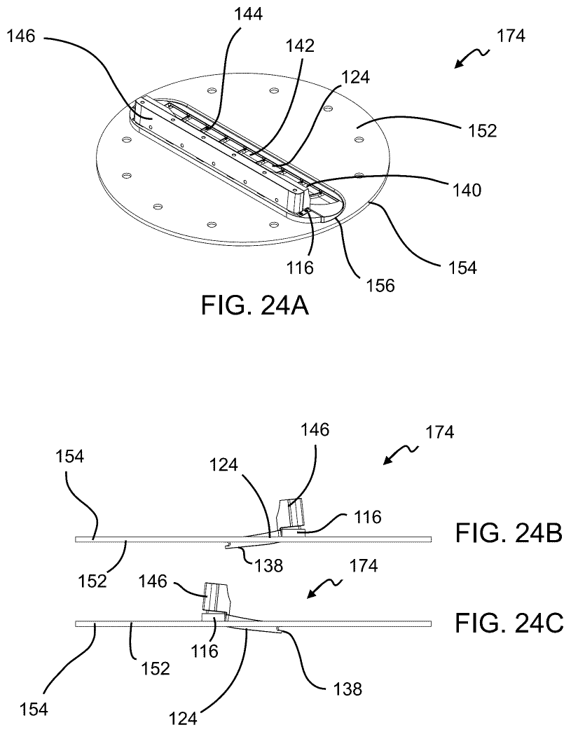

FIGS. 24A-24C illustrate a retrofit embodiment configured for round open lower boundary applications. FIG. 24A illustrates a front top isometric view of a nozzle insert assembly 174 including a fitting frame 116 and a flow guiding nozzle flap 124. In the illustrated embodiment, the fitting frame 116 interfaces with an intermediary plate 152 at an inner open periphery 156. The intermediary plate has an outer boundary 154 for interfacing with an open lower boundary of a sea chest. The flow guiding nozzle flap 124 may include a concave top surface 140 and a plurality of flow channels 142 defined by upward protrusions 144. In some embodiments, the flow guiding nozzle flap 124 may further include a removable counterweight 146. FIG. 24B illustrates a side elevation view of the retrofit embodiment including the intermediary plate 152 and outer boundary 154 with the flow guiding nozzle flap 124 shown in an open position 138 relative to the fitting frame 116 of the nozzle insert assembly 174. FIG. 24C illustrates an opposing side elevation view of the retrofit embodiment including the nozzle insert assembly 174, the intermediary plate 152 with outer boundary 154, the fitting frame 116, the flow guiding nozzle flap 124 in the open position 138, and the removable counterweight 146.

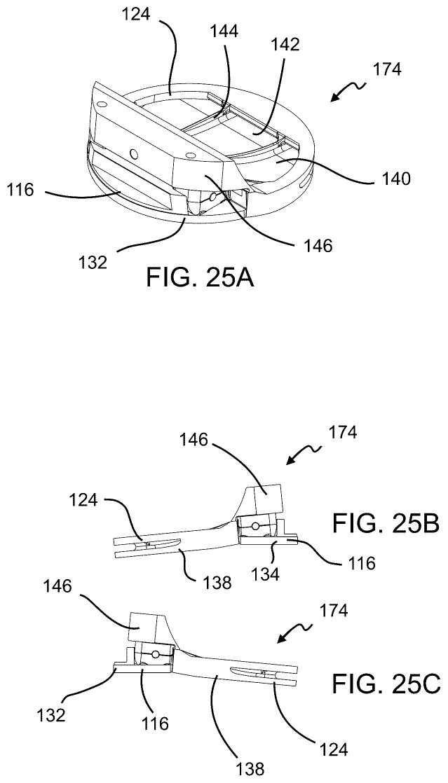

FIGS. 25A-25C illustrate an additional retrofit embodiment configured for round open lower boundary applications. Similar to the embodiment shown in FIGS.24A-24C, the figures illustrate isometric and side elevation views of a nozzle insert assembly 174 configured for installation within smaller round sea chest installations. In this embodiment, the fitting frame 116 does not form a closed loop and instead affixes at one end in a semi-circumferential configuration. FIG. 25A illustrates a front top isometric view of the nozzle insert assembly 174 including the fitting frame 116 and the flow guiding nozzle flap 124. In the illustrated embodiment, the flow guiding nozzle flap 124 may include a concave top surface 140 and a plurality of flow channels 142 defined by upward protrusions 144, and may further include a removable counterweight 146. FIG. 25B illustrates a side elevation view of the nozzle insert assembly 174 including the flow guiding nozzle flap 124 in an open position 138 relative to the fitting frame 116. FIG. 25C illustrates an opposing side elevation view of the nozzle insert assembly 174 including the flow guiding nozzle flap 124 in the open position 138 relative to the fitting frame 116, with the removable counterweight 146 positioned along the flow guiding nozzle flap 124.

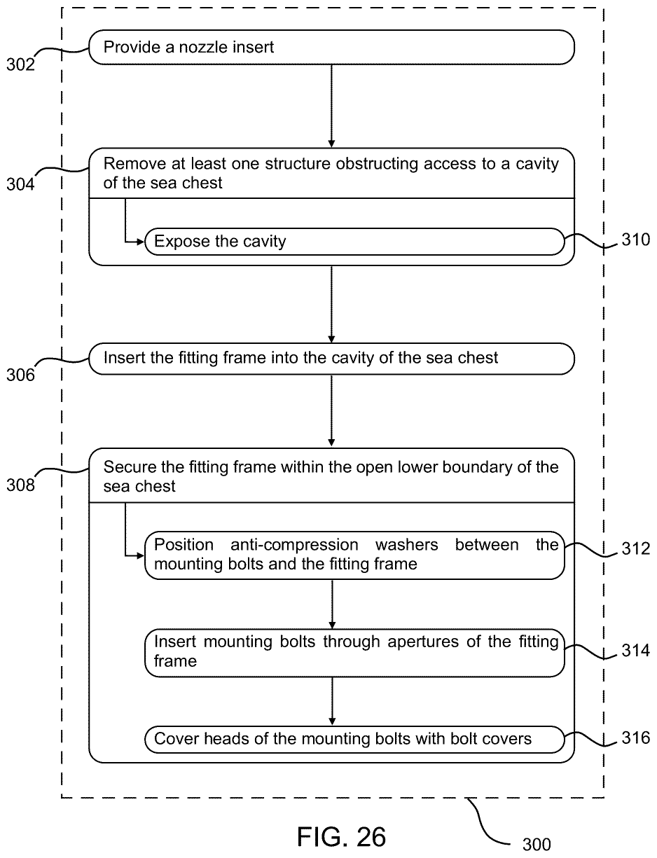

FIG. 26 illustrates a flow diagram of the method 300 for retrofitting a marine vessel 170 with an air layer drag reduction nozzle insert 174. The method 300 includes providing 302 a nozzle insert 174. As described above, the nozzle insert 174 includes a fitting frame 116 and a flow guiding nozzle flap 124 connecting the flow guiding nozzle flap 124 to the sea chest 104. The fitting frame 116 is configured to be removably affixed within an open lower boundary 110 of a sea chest 104. The fitting frame 116 has an outer surface 120 configured to conform to a complementary geometry of the open lower boundary 110 and an inner surface 118 defining an opening 122. The flow guiding nozzle flap 124 is positioned within the opening 122 of the fitting frame 116. The hinge connection 128 couples a forward edge 126 of the flow guiding nozzle flap 124 to an inner surface 118 of a forward portion of the fitting frame 116 along a lateral axis 130 extending between a port side 132 and a starboard side 134 of the fitting frame 116. The flow guiding nozzle flap 124 is rotatable about the lateral axis 130 between a closed position 136 and an open position 138. The method 300 further includes removing 304 at least one structure 400 obstructing access to a cavity 106 of the sea chest 104, thereby exposing 310 the cavity 106. The cavity 106 provides geometric space configured to receive the nozzle insert 174. The method 300 includes inserting 306 the fitting frame 116 into the cavity 106 of the sea chest 104 such that the fitting frame 116 is positioned within the open lower boundary 110 of the sea chest 104. The method 300 includes securing 308 the fitting frame 116 within the open lower boundary 110 of the sea chest 104 by positioning 312 anti-compression washers 164 between the mounting bolts 162 and the fitting frame 116, inserting 314 mounting bolts 162 through the center opening 164c of the anti-compression washers 164 and through the apertures 158 of the fitting frame 116, and covering 316 heads of the mounting bolts 162 with bolt covers 166 such that an outer surface 166a of the fitting frame forms a substantially flush transition with an exterior surface of a hull 168 of the marine vessel 170.

In an exemplary embodiment, an air layer drag reduction system nozzle assembly 102 is disclosed. The air layer drag reduction system nozzle assembly 102 includes a sea chest 104 and a flow guiding nozzle flap 124. The sea chest 104 has an open cavity 106 therein. The sea chest includes a gas flow inlet 108, and an open lower boundary 110 configured to receive a flow guiding nozzle flap 124. The system 102 includes the flow guiding nozzle flap 124. The flap 124 is configured to guide a direction and flow rate of a gaseous flow 176. The sea chest 104 has at least one longitudinal engagement area 112. The at least one longitudinal engagement area 112 is a rigidly fixed semi-circumferential bracket 114 for mounting the flow guiding nozzle flap 124. The rigidly fixed semi-circumferential bracket 114 is affixed at least semi-circumferentially at a border of the open lower boundary 110. The at least one longitudinal engagement area 112 includes a removably affixed at least semi-circumferential fitting frame 116. The flow guiding nozzle flap 124 is coupled to the at least one longitudinal engagement area 112 by the fitting frame 116. The air layer drag reduction system nozzle assembly 102 is operable in a submerged environment.

In some embodiments, an outer boundary 120 of the fitting frame 116 is configured to conform to a geometry of the open lower boundary 110 of the sea chest 104.

In some embodiments, the fitting frame 116 includes an inner surface 118 defining an opening 122 configured to conform to a complementary geometry of the flow guiding nozzle flap 124 and an outer surface 120 configured to conform to a complementary geometry of the open lower boundary 110 of the sea chest 104.

In some embodiments, the at least one longitudinal engagement area 112 further includes an intermediary plate 152 positioned between the sea chest 104 and the fitting frame 116. The intermediary plate 152 has an outer boundary 154 configured to conform to a geometry of the open lower boundary 110 of the sea chest 104 and an inner open periphery 156 with a boundary configured to couple with the fitting frame 116.

The fitting frame 116 can include an inner surface 118 defining an opening 122 configured to conform to a complementary geometry of the flow guiding nozzle flap 124 and an outer surface 120 configured to conform to a complementary geometry of an open inner periphery 156 of the intermediary plate 152.

In some embodiments, a forward edge 126 of the flow guiding nozzle flap 124 is coupled to an inner surface 118 of a forward portion of the fitting frame 116 by a hinge connection 128 defining a lateral axis 130 extending between a port side 132 and a starboard side 134 of the fitting frame 116, and wherein the flow guiding nozzle flap 124 is rotatable about the lateral axis 130 between a closed position 136 and an open position 138.

In some embodiments, the fitting frame 116 forms a closed loop, as may be seen in FIG. 15, or as may be appreciated in FIGS. 24A-24C. In some embodiment, such as those in FIGS. 25A-25C, the fitting frame 116 is instead semi-circumferential, whereby it can still affix the flap 124 to the sea chest 104.

In some embodiments, the fitting frame 116 includes a plurality of apertures 158 configured to align with threaded apertures 160 of the at least one longitudinal engagement area 112.

In some embodiments, air layer drag reduction system nozzle assembly 102 further comprises a plurality of mounting bolts 162 extending through the apertures 158/160, anti-compression washers 164 can be positioned between the bolts 162 and the fitting frame 116, and bolt covers 166 are configured to cover heads of the mounting bolts 162. The bolt covers 166 provide a smoothed external surface 166a.

In some embodiments of the air layer drag reduction system nozzle assembly 102, a top surface 140 of the flow guiding nozzle flap 124 includes a concave curvature, as may be seen in FIG. 10B, configured to direct gaseous flow 176 from the gas flow inlet 108 toward an axial direction parallel to a hull surface 168.

In some embodiments, the flow guiding nozzle flap 124 includes a plurality of flow channels 142 extending from a forward region 126 to a rear region of the flow guiding nozzle flap 124, each flow channel 142 is defined by an upper surface 140 of the flow guiding nozzle flap 124, and upward protrusions 144 forming sidewalls.

In some embodiments, the air layer drag reduction system nozzle assembly 102 includes a removable counterweight 146 positioned at a forward 126 upper region of the flow guiding nozzle flap 124 and configured to bias the flow guiding nozzle flap 124 toward a closed position 136. In some embodiments, a rear section of the counterweight 146 includes at least one concave flow channel 150 configured to direct gaseous flow 176 toward flow channels 142 of the flow guiding nozzle flap 124. In some embodiments, the counterweight 146 comprises a sacrificial anode 148.

In an exemplary embodiment, an air layer drag reduction nozzle insert 174 is disclosed. The insert 174 includes a fitting frame 116 and a flow guiding nozzle flap 116. The fitting frame 116 is configured to be removably affixed within an open lower boundary 110 of a sea chest 104. The fitting frame 116 has an outer surface 120 configured to conform to a complementary geometry of the open lower boundary 110 and an inner surface 118 defining an opening 122. The flow guiding nozzle flap 124 is positioned within the opening 122 of the fitting frame 116. The insert 174 includes a hinge connection 128 coupling a forward edge 126 of the flow guiding nozzle flap 124 to an inner surface 118 of a forward portion of the fitting frame 116 along a lateral axis 130 extending between a port side 132 and a starboard side 134 of the fitting frame 116. The flow guiding nozzle flap 124 is rotatable about the lateral axis 130 between a closed position 136 and an open position 138.

In some embodiments, the fitting frame 116 includes an inner surface 118 defining an opening 122 configured to conform to a complementary geometry of the flow guiding nozzle flap 124 and an outer surface 120 configured to conform to a complementary geometry of the open lower boundary 110 of the sea chest 104 or an intermediary plate 152. In some embodiments, the outer surface 120 is configured to conform to a complementary geometry of an open inner periphery 156 of the intermediary plate 152.

In some embodiments, the fitting frame forms a closed loop, as may be seen in FIG. 15, or as may be appreciated in FIGS. 24A-24C. In some embodiment, such as those in FIGS. 25A-25C, the fitting frame 116 is instead semi-circumferential, whereby it can still affix the flap 124 to the sea chest 104.

In some embodiments, the fitting frame 116 includes a plurality of apertures 158 configured for mounting the fitting frame 116 to a sea chest 104 or an intermediary plate 152. Some embodiments include a plurality of mounting bolts 162 extending through the apertures 158/160, anti-compression washers 164 can be positioned between the bolts 162 and the fitting frame 116, and bolt covers 166 are configured to cover heads of the mounting bolts 162. The bolt covers 166 provide a smoothed external surface 166a.

In some embodiments, a top surface 140 of the flow guiding nozzle flap 124 includes a concave curvature configured to direct a gaseous flow 176 toward an axial direction parallel to a hull surface 168.

In some embodiments of the insert 174, the flow guiding nozzle flap 124 includes a plurality of flow channels 142 extending from a forward region 126 to a rear region of the flow guiding nozzle flap 124, each flow channel 142 is defined by an upper surface 140 of the flow guiding nozzle flap 124, and upward protrusions 144 forming sidewalls.

In some embodiments, the insert 174 further includes a removable counterweight 146 positioned at a forward upper region of the flow guiding nozzle flap 124 and configured to bias the flow guiding nozzle flap 124 toward a closed position 136. In some embodiments, a rear section of the counterweight 146 includes at least one concave flow channel 150 configured to direct gaseous flow 176 toward flow channels 142 of the flow guiding nozzle flap 124.

In some embodiments, the fitting frame 116 includes a depth configured to position the flow guiding nozzle flap 124 within a sea chest 104 cavity 106 such that an outer surface of the fitting frame 116 forms a substantially flush transition with an outer hull surface 168 of a marine vessel 170 when installed, as may be appreciated from views of FIGS. 1 and 3A.

In another exemplary embodiment, a method 300 for retrofitting a marine vessel 170 with an air layer drag reduction nozzle insert 174 is disclosed. The method 300 includes providing 302 a nozzle insert 174. As described above, the nozzle insert 174 includes a fitting frame 116 and a flow guiding nozzle flap 124 connecting the flow guiding nozzle flap 124 to the sea chest 104. The fitting frame 116 is configured to be removably affixed within an open lower boundary 110 of a sea chest 104. The fitting frame 116 has an outer surface 120 configured to conform to a complementary geometry of the open lower boundary 110 and an inner surface 118 defining an opening 122. The flow guiding nozzle flap 124 is positioned within the opening 122 of the fitting frame 116. The hinge connection 128 couples a forward edge 126 of the flow guiding nozzle flap 124 to an inner surface 118 of a forward portion of the fitting frame 116 along a lateral axis 130 extending between a port side 132 and a starboard side 134 of the fitting frame 116. The flow guiding nozzle flap 124 is rotatable about the lateral axis 130 between a closed position 136 and an open position 138.

The insert 174 may include a hinge connection 128 coupling a forward edge 126 of the flow guiding nozzle flap 124 to an inner surface 118 of a forward portion of the fitting frame 116 along a lateral axis 130 extending between a port side 132 and a starboard side 134 of the fitting frame 116. The flap 124 of the insert 174 may include a top surface 140 having a concave curvature configured to direct a gaseous flow 176 toward an axial direction parallel to a hull surface 168. The top surface 140 of the flap may include a plurality of flow channels 142 extending from a forward region 126 to a rear region of the flow guiding nozzle flap 124, each flow channel 142 is defined by an upper surface 140 of the flow guiding nozzle flap 124 and upward protrusions 144 forming sidewalls. The flap 124 may include a removable counterweight 146 positioned at a forward upper region of the flow guiding nozzle flap 124 and configured to bias the flow guiding nozzle flap 124 toward a closed position 136.

In some embodiments, the method 300 further includes removing 304 at least one structure 400 obstructing access to a cavity 106 of the sea chest 104, thereby exposing 310 the cavity 106. The cavity 106 provides geometric space configured to receive the nozzle insert 174.

In some embodiments, the method 300 includes inserting 306 the fitting frame 116 into the cavity 106 of the sea chest 104 such that the fitting frame 116 is positioned within the open lower boundary 110 of the sea chest 104.

In some embodiments, the method 300 includes securing 308 the fitting frame 116 within the open lower boundary 110 of the sea chest 104 by positioning 312 anti-compression washers 164 between the mounting bolts 162 and the fitting frame 116, inserting 314 mounting bolts 162 through the center opening 164 c of the anti-compression washers 164 and through the apertures 158 of the fitting frame 116, and covering 316 heads of the mounting bolts 162 with bolt covers 166 such that an outer surface 166a of the fitting frame forms a substantially flush transition with an exterior surface of a hull 168 of the marine vessel 170.

A key advantage of this system is that it can be retrofit-installed without requiring the vessel to enter dry dock, significantly reducing downtime and operational disruption. The retrofit process can be performed while the vessel is in port, utilizing existing underwater installation techniques or divers to secure the fitting frame and nozzle flap assembly in place. This capability makes the system highly practical for a wide range of vessels, allowing operators to implement the retrofit during routine maintenance stops rather than undergoing costly and time-consuming dry docking procedures. By enabling seamless integration with minimal vessel downtime, this invention provides a realistic and economically viable retrofit solution for improving air lubrication and air layer drag reduction system performance by implementing air layer drag reduction.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. An air layer drag reduction system nozzle assembly, comprising:
a sea chest having an open cavity therein, wherein said sea chest includes a gas flow inlet, and an open lower boundary configured to receive a flow guiding nozzle flap;
a flow guiding nozzle flap, wherein said flap is configured to guide a direction and flow rate of a gaseous flow;
said sea chest having at least one longitudinal engagement area, wherein said at least one longitudinal engagement area is a rigidly fixed semi-circumferential bracket for mounting said flow guiding nozzle flap, wherein said rigidly fixed semi-circumferential bracket is affixed at least semi-circumferentially at a border of said open lower boundary, and wherein said at least one longitudinal engagement area includes a removably affixed at least semi-circumferential fitting frame;
said flow guiding nozzle flap is coupled to said at least one longitudinal engagement area, wherein said flow guiding nozzle flap is coupled to said at least one longitudinal engagement area by said fitting frame; and
wherein said air layer drag reduction system nozzle assembly is operable in a submerged environment.

2. The air layer drag reduction system nozzle assembly, as recited in claim 1, wherein an outer boundary of said fitting frame is configured to conform to a geometry of said open lower boundary of said sea chest.

3. The air layer drag reduction system nozzle assembly, as recited in claim 1, wherein said fitting frame includes an inner surface defining an opening configured to conform to a complementary geometry of said flow guiding nozzle flap and an outer surface configured to conform to a complementary geometry of said open lower boundary of said sea chest.

4. The air layer drag reduction system nozzle assembly, as recited in claim 1, wherein said at least one longitudinal engagement area further includes:
an intermediary plate positioned between said sea chest and said fitting frame; and
said intermediary plate having an outer boundary configured to conform to a geometry of said open lower boundary of said sea chest and an inner open periphery with a boundary configured to couple with said fitting frame.

5. The air layer drag reduction system nozzle assembly, as recited in claim 4, wherein said fitting frame includes an inner surface defining an opening configured to conform to a complementary geometry of said flow guiding nozzle flap and an outer surface configured to conform to a complementary geometry of an open inner periphery of said intermediary plate.

6. The air layer drag reduction system nozzle assembly, as recited in claim 1, wherein a forward edge of said flow guiding nozzle flap is coupled to an inner surface of a forward portion of said fitting frame by a hinge connection defining a lateral axis extending between a port side and a starboard side of said fitting frame, and wherein said flow guiding nozzle flap is rotatable about said lateral axis between a closed position and an open position.

7. The air layer drag reduction system nozzle assembly, as recited in claim 1, wherein said fitting frame forms a closed loop.

8. The air layer drag reduction system nozzle assembly, as recited in claim 7, wherein said fitting frame includes a plurality of apertures configured to align with threaded apertures of said at least one longitudinal engagement area.

9. The air layer drag reduction system nozzle assembly, as recited in claim 8, further comprising:
a plurality of mounting bolts extending through said apertures, anti-compression washers positioned between said bolts and said fitting frame, and bolt covers configured to cover heads of said mounting bolts, wherein said bolt covers provide a smoothed external surface.

10. The air layer drag reduction system nozzle assembly, as recited in claim 1, wherein a top surface of said flow guiding nozzle flap includes a concave curvature configured to direct gaseous flow from said gas flow inlet toward an axial direction parallel to a hull surface.

11. The air layer drag reduction system nozzle assembly, as recited in claim 1, wherein said flow guiding nozzle flap includes a plurality of flow channels extending from a forward region to a rear region of said flow guiding nozzle flap, each flow channel defined by an upper surface of said flow guiding nozzle flap, and upward protrusions forming sidewalls.

12. The air layer drag reduction system nozzle assembly, as recited in claim 1, further comprising a removable counterweight positioned at a forward upper region of said flow guiding nozzle flap and configured to bias said flow guiding nozzle flap toward a closed position.

13. The air layer drag reduction system nozzle assembly, as recited in claim 12, wherein said counterweight comprises a sacrificial anode.

14. The air layer drag reduction system nozzle assembly, as recited in claim 12, wherein a rear section of said counterweight includes at least one concave flow channel configured to direct gaseous flow toward flow channels of said flow guiding nozzle flap.

15. An air layer drag reduction nozzle insert, comprising:
a fitting frame configured to be removably affixed within an open lower boundary of a sea chest, said fitting frame having an outer surface configured to conform to a complementary geometry of said open lower boundary and an inner surface defining an opening;
a flow guiding nozzle flap positioned within said opening of said fitting frame;
a hinge connection coupling a forward edge of said flow guiding nozzle flap to an inner surface of a forward portion of said fitting frame along a lateral axis extending between a port side and a starboard side of said fitting frame; and
wherein said flow guiding nozzle flap is rotatable about said lateral axis between a closed position and an open position.

16. The air layer drag reduction nozzle insert, as recited in claim 15, wherein said fitting frame includes an inner surface defining an opening configured to conform to a complementary geometry of said flow guiding nozzle flap and an outer surface configured to conform to a complementary geometry of said open lower boundary of said sea chest or an intermediary plate.

17. The air layer drag reduction nozzle insert, as recited in claim 15, wherein said fitting frame includes an inner surface defining an opening configured to conform to a complementary geometry of said flow guiding nozzle flap and an outer surface configured to conform to a complementary geometry of an open inner periphery of said intermediary plate.

18. The air layer drag reduction nozzle insert, as recited in claim 15, wherein said fitting frame forms a closed loop.

19. The air layer drag reduction nozzle insert, as recited in claim 15, wherein said fitting frame includes a plurality of apertures configured for mounting said fitting frame to a sea chest or an intermediary plate.

20. The air layer drag reduction nozzle insert, as recited in claim 19, further comprising:
a plurality of mounting bolts extending through said apertures, anti-compression washers positioned between said bolts and said fitting frame, and bolt covers configured to cover heads of said mounting bolts, wherein said bolt covers provide a smoothed external surface.

21. The air layer drag reduction nozzle insert, as recited in claim 15, wherein a top surface of said flow guiding nozzle flap includes a concave curvature configured to direct a gaseous flow toward an axial direction parallel to a hull surface.

22. The air layer drag reduction nozzle insert, as recited in claim 15, wherein said flow guiding nozzle flap includes a plurality of flow channels extending from a forward region to a rear region of said flow guiding nozzle flap, each flow channel defined by an upper surface of said flow guiding nozzle flap, and upward protrusions forming sidewalls.

23. The air layer drag reduction nozzle insert, as recited in claim 15, further comprising a removable counterweight positioned at a forward upper region of said flow guiding nozzle flap and configured to bias said flow guiding nozzle flap toward a closed position.

24. The air layer drag reduction nozzle insert, as recited in claim 23, wherein a rear section of said counterweight includes at least one concave flow channel configured to direct gaseous flow toward flow channels of said flow guiding nozzle flap.

25. The air layer drag reduction nozzle insert, as recited in claim 15, wherein said fitting frame includes a depth configured to position said flow guiding nozzle flap within a sea chest cavity such that an outer surface of said fitting frame forms a substantially flush transition with an outer hull surface of a marine vessel when installed.

26. A method for retrofitting a marine vessel with an air layer drag reduction nozzle insert, comprising:
providing a nozzle insert, wherein said nozzle insert comprises:
a fitting frame configured to be removably affixed within an open lower boundary of a sea chest, said fitting frame having an outer surface configured to conform to a complementary geometry of said open lower boundary and an inner surface defining an opening;
a flow guiding nozzle flap positioned within said opening of said fitting frame; and
a hinge connection coupling a forward edge of said flow guiding nozzle flap to an inner surface of a forward portion of said fitting frame along a lateral axis extending between a port side and a starboard side of said fitting frame, wherein said flow guiding nozzle flap is rotatable about said lateral axis between a closed position and an open position.

27. The method for retrofitting a marine vessel with an air layer drag reduction nozzle insert, as recited in claim 26, further comprising:
removing at least one structure obstructing access to a cavity of said sea chest, thereby exposing said cavity, wherein said cavity provides geometric space configured to receive said nozzle insert.

28. The method for retrofitting a marine vessel with an air layer drag reduction nozzle insert, as recited in claim 27, further comprising:
inserting said fitting frame into said cavity of said sea chest such that said fitting frame is positioned within said open lower boundary of said sea chest.

29. The method for retrofitting a marine vessel with an air layer drag reduction nozzle insert, as recited in claim 28, further comprising:
securing said fitting frame within said open lower boundary of said sea chest by inserting mounting bolts through apertures of said fitting frame, positioning anti-compression washers between said mounting bolts and said fitting frame, and covering heads of said mounting bolts with bolt covers such that an outer surface of said fitting frame forms a substantially flush transition with an exterior surface of a hull of said marine vessel.

30. The method for retrofitting a marine vessel with an air layer drag reduction nozzle insert, as recited in claim 26, wherein said flow guiding nozzle flap of said step of providing a nozzle insert, further includes:
a hinge connection coupling a forward edge of said flow guiding nozzle flap to an inner surface of a forward portion of said fitting frame along a lateral axis extending between a port side and a starboard side of said fitting frame;
a top surface having a concave curvature configured to direct a gaseous flow toward an axial direction parallel to a hull surface;
a plurality of flow channels extending from a forward region to a rear region of said flow guiding nozzle flap, each flow channel defined by an upper surface of said flow guiding nozzle flap and upward protrusions forming sidewalls; and
a removable counterweight positioned at a forward upper region of said flow guiding nozzle flap and configured to bias said flow guiding nozzle flap toward a closed position.
